(19) United States
(12) Patent Application Publication
(10) Pub. No.: US 2023/0066098 A1
(43) Pub. Date: Mar. 2, 2023

(54) METHODS FOR CATEGORIZING INFORMATION FROM A PLATFORM IN A DOCUMENT MANAGEMENT SYSTEM

(71) Applicant: Kyocera Document Solutions Inc., Osaka (JP)

(72) Inventor: Jin LIANG, Dublin, CA (US)

(73) Assignee: Kyocera Document Solutions Inc., Osaka (JP)

(21) Appl. No.: 17/460,976

(22) Filed: Aug. 30, 2021

(51) Int. Cl. G06F 16/35; G06F 16/383; G06Q 10/06; H04L 12/18

(52) U.S. Cl. CPC G06F 16/355; G06F 16/383; G06Q 10/06313; H04L 12/1831

(57) ABSTRACT

A document management system retrieves data from discussion and notes generated during sessions and meetings hosted by a third-party meeting platform. The data is in the form of textual data. The document management system also defines and determines keywords to use in processing the data from the platform. A processing engine generates a document from the data and identifies one or more keywords within the document. It then categorizes the document according to the identified keywords and stores the document under a categories related to the keywords at a document management server. Access to the categorized documents on the document management server is controlled by a policy applicable to users within the document management system.

### FIELD OF THE INVENTION

The present invention relates to automatically categorizing meeting and discussion notes from meeting platforms in a document management system.

### DESCRIPTION OF THE RELATED ART

As more people work from home, they are use meeting platforms, such as WEBEX™ SLACK™, TEAMS™, ZOOM™, and the like, to conduct video or other conferences with co-workers, customers, colleagues, and the like. Meeting platforms may include chats and notes that are entered by attendees during the meeting. It is hard to keep track of these chats and notes and they are not make readily available following the meeting. Someone has to spend time to search old notes from the meeting platforms. Further, it is unclear which notes are relevant and to what category, topic, project, if any, that they belong to.

### SUMMARY OF THE INVENTION

A method for automatically processing data for meetings and discussions in a document management system. The method includes retrieving textual data from a third-party meeting platform. The method also includes processing the textual data to identify at least keyword using a processing engine. The method also includes generating at least one document from the textual data. The method also includes categorizing the at least one document according to the at least one keyword into a category within the document management system. The method also includes storing the at least one document at a document management server under the category. The method also includes receiving a request to access the at least one document from the category within the document management system. The method also includes allowing access to the at least one document based on a policy at the document management server.

A method for automatically processing data for meetings and discussions in a document management system is disclosed. The method includes defining a project within the document management system. The method also includes, using a processing engine, calling an application programming interface to retrieve a card from a task management system related to the project. The method also includes retrieving textual data from a third-party meeting platform related to the project or the card. The method also includes processing the textual data to identify at least one keyword associated with the project using the processing engine. The method also includes generating a document from the textual data. The method also includes categorizing the document according to the at least one keyword into a category under the project within the document management system. The method also includes storing the document at a document management server under the project. The method also includes receiving a request to access the document from the category within the document management system. The method also includes allowing access to the document based on a policy related to the project at the document management server.

A method for automatically processing data for meetings and discussions in a document management system. The method includes defining a group within the document management system. The group includes at least one member account. The method also includes retrieving textual data from a third-party meeting platform related to the group. The method also includes processing the textual data to identify the at least one member account associated with the group using a processing engine. The method also includes generating a document from the textual data. The method also includes categorizing the document according to the at least one member account into a category for the group within the document management system. The method also includes storing the document at a document management server under the group. The method also includes receiving a request to access the document from the category within the document management system. The method also includes allowing access to the document based on a policy related to the project at the document management server.

### BRIEF DESCRIPTION OF THE DRAWINGS

Various other features and attendant advantages of the present invention will be more fully appreciated when considered in conjunction with the accompanying drawings.

FIG. 1 illustrates a block diagram of a document management system for categorizing data from notes and discussions on a third-party meeting platform according to the disclosed embodiments.

FIG. 2 illustrates a block diagram of an example architecture for the third-party meeting platform for use with the document management system according to the disclosed embodiments.

FIG. 3 illustrates a processing engine within the document management system according to the disclosed embodiments.

FIG. 4 illustrates the document management server for managing categorized documents within the document management system according to the disclosed embodiments.

FIG. 5A illustrates a flow diagram of a document being categorized according to keywords according to the disclosed embodiments.

FIG. 5B further illustrates the flow diagram of the document being categorized according to the keywords according to the disclosed embodiments.

FIG. 6 illustrates a flowchart for categorizing a document related to notes and discussions of a meeting according to the disclosed embodiments.

FIG. 7 illustrates a flowchart for accessing categorized documents within the document management system according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments provide a solution that allows a document management system to keep notes from any discussion between team members. The disclosed embodiments may find quickly relevant information in one system and improve productivity within the organization. The document management system automatically collects daily notes from a third-party meeting platform conversation and discussion. It then categorizes the notes into documents, and posts the documents in the document management system with access control setup based on policies.

In some embodiments, these documents may be categorized by project name, project management tool card, or feature name. For example, projects may be pre-defined on the document management system. The same projects may be created and managed on task management system or work or project management tool. A processing engine calls the project management tool application programming interfaces to retrieve all tool management cards in each project. This process may run automatically on a daily basis to update the latest cards. The processing engine retrieves notes from the meeting platform and finds matched keywords for project names, project management tool cards, and feature names. This process also may execute daily. The processing engine saved the keyword matched notes to documents that are categorized by the project names, project management tool cards, and feature names.

In other embodiments, the documents may be categorized by member, role, or group. For example, participants in the group or project may be defined by the member name or role, such as Jin Liang/developer, Michael Martin/manager, or William Nixon/attorney. Roles may include programmer or project manager. An example group may be development team. Member user accounts and groups are created on the document management system. The processing engine retrieves notes from the third-party meeting platform. It then finds the owners of the notes. The engine categorizes the documents and saved them according to the owners/members and the defined groups.

The documents also may be categorized by question and answer. The disclosed embodiments identify questions in the discussion or notes from the meeting and then the subsequent answers. The disclosed embodiments may make a list of the questions and answers for later retrieval be members. In the question and answer category, a user may see, or search by keywords, a list of questions and answers.

When documents are listed under one category, the disclosed embodiments may show the relevance to other categories. For example, under the “LiteDMS” category, a document is relevant to another category for “Jin Liang.” In other words, a document may be categorized under a project name as well as a group name or member name. In another example, a document may be categorized under a member name, which then shows any related groups to which the document may also relate.

The disclosed embodiments also may control access to the documents based on policies. These access policies may be defined by an administrator or the document management system. The document management system finds the categories and the documents that can be accessed by a user based on the policies. Once access is confirmed, the document management system may display the categories and the documents. Policy examples include each member accessing categories under his/her name or member name, categories in his/her group, categories of the project in which the member is involved, and documents that mention his/her name. Other criteria also may be defined, such as all managers.

The disclosed embodiments allow users to easily find relevant information after the meeting and discussion held on the meeting platform. They also promote information sharing within the team and certain groups. The business or organization will benefit from improved productivity. The categorized documents will be stored and made available as needed.

In some embodiments, the disclosed process may be as follows. The disclosed embodiments automatically retrieve daily notes from the third-party meeting platform discussions and meetings. The processing engine classifies the notes and categorizes them into documents. The categorized documents are saved to the document management system, preferably at a document management server. A user can view the documents in different categories with access control, such as through policies.

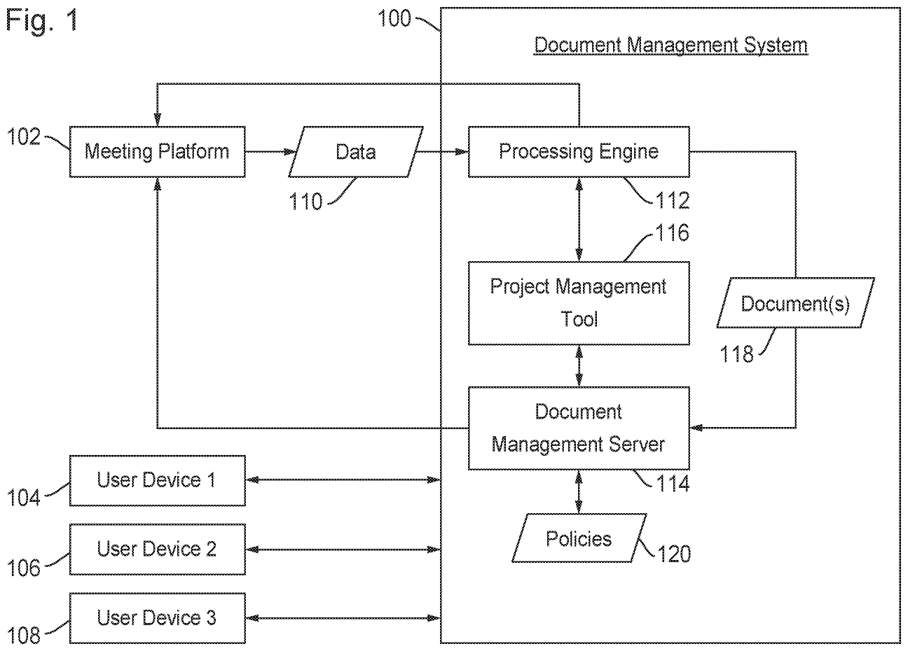

FIG. 1 depicts a block diagram of a document management system 100 for categorizing data from notes and discussions on a third-party meeting platform 102 according to the disclosed embodiments. Document management system 100 interacts with third-party meeting platform 102 and user devices 104, 106, and 108 to download and categorize meeting and discussion notes, shown as data 110.

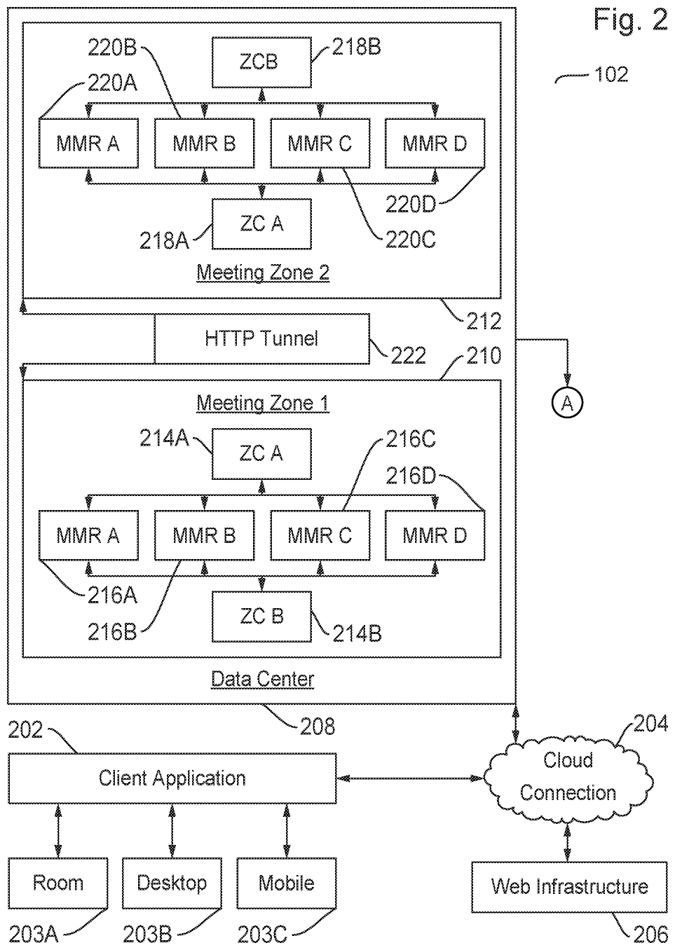

Third-party meeting platform 102, as disclosed above, may be an enterprise video communication platform that provides for video and audio conferencing, collaboration, chat, and webinars across mobile devices, desktop computers, telephones, and room systems. Meeting platform 102 is disclosed in greater detail by FIG. 2.

FIG. 2 depicts a block diagram of an example architecture for third-party meeting platform 102 for use with document management system 100 according to the disclosed embodiments. FIG. 2 may show the key components of meeting platform 102 for conducting meetings and discussions that produce data and information to be used by document management system 100. Client application 202 may be an individual's primary feature for accessing the architecture of meeting platform 102. Client application 202 may be available for multiple operating systems, such as macOS™, Windows™, Linux™, Andriod™, iOS™, ChromeOS™, and the like. Client application 202 also may be available in range of context-aware applications for rooms 203A, desktop 203B, and mobile device 203C. Interactions by client application 202 should remain the same across all configurations.

Client application 202 may connect with cloud connection 204. Connection 204 facilitates a connection process across a cloud platform to meeting platform 102. Connection 204 provides a path to the infrastructure of meeting platform 102. In some instances, this path is optimized across a distributed infrastructure for meeting platform 102.

Web infrastructure 206 may be a web application that helps host a website accessed by users accessing meeting platform 102. It also helps service application requests through application programming interface (API) resources that are leveraged by the various components of the infrastructure of meeting platform 102.

Meeting platform 102 also includes data center 208, which may represent the different components to conduct meetings and discussions. These components may be located in a specific location or may be distributed. Meeting platform 102 also may include multiple data centers in different locations to host meetings and provide services. Data center 208 may include meeting zones, shown as meeting zones 210 and 212. A meeting zone is a logical association of servers that are typically physically co-located that can host a meeting session. A meeting zone and its associated servers may be located within data center 208 or may be located within an organization's network if running an on-premise solution or dedicated within the organization. The primary components for a meeting zone may be multimedia routers and zone controllers.

Meeting zone 210 includes zone controllers 214A and 214B. Meeting zone 212 includes zone controllers 218A and 218B. A zone controller is responsible for the management and orchestration of all activity that occurs within the respective meeting zone. Zone controllers track the load on all servers within the meeting zone and help broker requests for new connections into the meeting zone. Thus, zone controllers 214A and 214B are responsible for the servers in meeting zone 210 as well as connections into the meeting zone. Zone controllers 218A and 218B provide the same services for meeting zone 212. Meeting zones may use more than one zone controller.

Meeting zone 210 also includes multimedia routers 216A, 216B, 216C, and 216D. Meeting zone 212 also include multimedia routers 220A, 220B, 220C, and 220D. Multimedia routers are servers that are responsible for hosting meetings and webinars within the respective meeting zone. Multimedia routers ensure that offerings of voice, video, and content are properly distributed between all participants in a given session.

Data center 208 also includes HTTP tunnel 222. HTTP tunnel 222 may be part of a tunnel service housed in various public clouds and data centers within meeting platform 102. The HTTP tunnel may be a server that offers a connection point to clients who are unable to connect to meeting platform 102 through other network channels. Once a tunnel is established between client application 202 and HTTP tunnel 222, the client application is able to access the meeting zone, such as meeting zone 210, across the various data centers.

Upon receiving a request to join a given session from room 203A, desktop 203B, or mobile device 203C, client application 202 may contact web infrastructure 206 via connection 204 to obtain the applicable metadata required to access the meeting or webinar. Client application 202 may use this opportunity to better understand its current network environment over a HTTPS connection. On the other side of the connection, web infrastructure 206 prepares a package of data optimized for client application 202. A list of optimum available meeting zones and associated zone controllers are returned to client application 202 along with meeting details so it can proceed to the next phase in the connection process.

With a list of meeting zones, such as meeting zones 210 and 212, that could service client application 202 for the session, the connection process than enters the next phase of the workflow. The ensure the best connection is used, client application 202 attempts to connect to each of the zone controllers within meeting zones provided in the previous phase and conducts a network performance test. Thus, client application 202 would attempt to connect to zone controllers 214A and 214B of meeting zone 210 and zone controllers 218A and 218B of meeting zone 212. It would then compare the results of the attempted connections to confirm there is a connectivity path in place to each meeting zone and select whichever one demonstrates the best performance.

After the optimum meeting zone is selected, client application 202 then requests details of the best multimedia router from the respective zone controller. Once identified, client application 202 reaches out to the multimedia router directly to establish a control channel for the session. For example, zone controller 214A of meeting zone 210 may identify multimedia router 216C as the best server for the session. With a success connection to multimedia router 216C, client application 202 prioritizes creating a connection for each type of media that will be exchanged such as video, audio, and content. Each of these media connections attempt to use the protocol of meeting platform 102. The connection for content may include the connection for text and notes created during the session.

After the session is complete, client application 202 may close the connection with multimedia router 216C. The content created, such as text, links, and other data within a chat on supported by multimedia router 216C may be stored therein or elsewhere within meeting platform 102. For the purposes of this example, the content, or data 110, will be stored at the servers/routers within the meeting zones. Document management system 100 will receive data 110 via a server application executed on document management server 114 or through processing engine 112. These components may access meeting platform 102 based on accounts to extract 110 from multimedia routers/servers at various times during the day. Alternatively, data 110 may be retrieved when instructed by a user or operator.

Referring back to FIG. 1, data 110 may be textual data generated during a session hosted by a meeting zone of meeting platform 102. Data 110 may be received by processing engine 112. Processing engine 112 classifies the text and data of data 110 and categorizes it into documents, such as document 118. Processing engine 112 also generates document 118 from data 110, as disclosed in greater detail below. Processing engine 112 also may call APIs of project management tool 116 to retrieve cards for each project being supported by the tool. It also may determine keywords to use in its operations from the cards or other information provided within document management system 102.

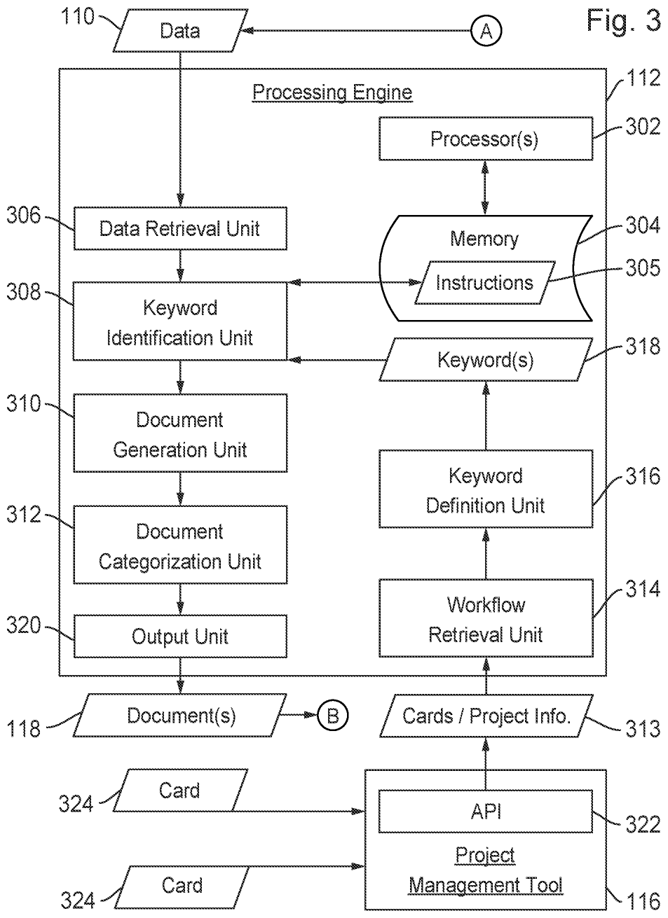

FIG. 3 depicts processing engine 112 within document management system 102 according to the disclosed embodiments. Processing engine 112 includes one or more processors 302 to enable the following components to perform various operations that allow the processing engine to receive data 110 to generate and classify document 118. Processor 302 accesses memory 304 to retrieve instructions 305 stored thereon. Instructions 305 configure processor 302 into processing engine 112. In some embodiments, a processor 302 may be used for each unit disclosed below along with specific instructions 305 for the respective processor. Processing engine 112 may be its own standalone device including processor 302 and memory 304 storing instructions 305. In other embodiments, processing engine 112 may be implemented at document management server 114.

Data retrieval unit 306 generates a request to meeting platform 102 to retrieve data 110 generated on the platform during discussions and meetings between users. Data 110 may be in the form of textual data, though it also may include hypertext links or attachments found within a chat or content from a meeting. Data retrieval unit 306 may format the incoming data into text, or a searchable format.

Keyword identification unit 308 receives keywords 318 related to projects, members, roles, and the like as defined by keyword definition unit 316, disclosed in greater detail below. Keywords 318 may be project names, member names for various projects, subjects related to projects, roles within a group, group names, and the like. Keywords 318 should apply to projects within project management tool 116. Keyword identification unit 308 sorts through the data to determine the presence of one or more keywords 318. More than one keyword may be identified. In some embodiments, keyword identification unit 308 may perform this task daily. Data may be stored in memory 304 until keyword identification unit 308 calls for it.

If any keywords are identified in the data, then document generation unit 310 generates a document for the data from the meeting or session. The disclosed embodiments may generate the document as an electronic document, such as a word processing document or PDF file. The resulting document should be searchable. Document generation unit 310 also may generate metadata for the document to include identified keywords and other information.

Processing engine 112 uses document categorization unit 312 to categorize the document according to the identified keywords therein. Processing engine 112 may have a list of applicable categories available for the keywords. More than one category may be selected based on the identified keywords. For example, data 110 may pertain to a meeting regarding the OS software development team having three members for an upcoming project. Keywords 318 may include the team name, the member accounts/names, and the project name. All these keywords are identified within the data and used to categorize the resulting document accordingly. Output unit 320 may receive the categorized document, shown as document 118, to send to document management server 114. In some embodiments, multiple documents 118 may be generated, depending on the amount of data 110 retrieved by processing engine 112.

Processing engine 112 also calls API 322 of project management tool 116 to retrieve cards or project information 313. Projects applicable to the disclosed embodiments are pre-defined within document management system 100 at project management tool 116. The same projects are created and managed using cards 324 in the project management tool. A card 324 may be referred to as a task card that specifies a feature or function in a project that members need to address or work on. A card 324 makes it easy to keep track of the details and progress of the development of each individual feature or function of the project being tracked by project management tool 116.

Workflow retrieval unit 314 may call API 322. It may call for card/project information 313 for specific projects listed in processing engine 112. Alternatively, it may call all cards 324 in each project. An organization, therefore, may define and create projects having information, such as project name, member names, and other information plus tasks to be accomplished for the project using cards 324. Workflow retrieval unit 314 may organize the information according to projects or other criteria.

Keyword definition unit 316 may review the retrieved information to define one or more keywords. It may review the incoming information for likely keywords, such as titles, names, identification numbers, roles, and the like. Keywords also may be defined within document management system 100 and provided to keyword definition unit 316. Document management server 114 also may provide keywords to processing engine 112. As disclosed above, keyword definition unit 316 provides one or more keywords 318 to keyword identification unit 308 to categorize meeting and discussion data for documents to be stored on document management server 114.

Referring back to FIG. 1, document 118 is generated and categorized by processing engine 112. It then is stored on document management server 114 for use later within document management system 100. The categorized documents also may be accessible by project management tool 116 to attach to cards 324 for project tasks, if categorized accordingly.

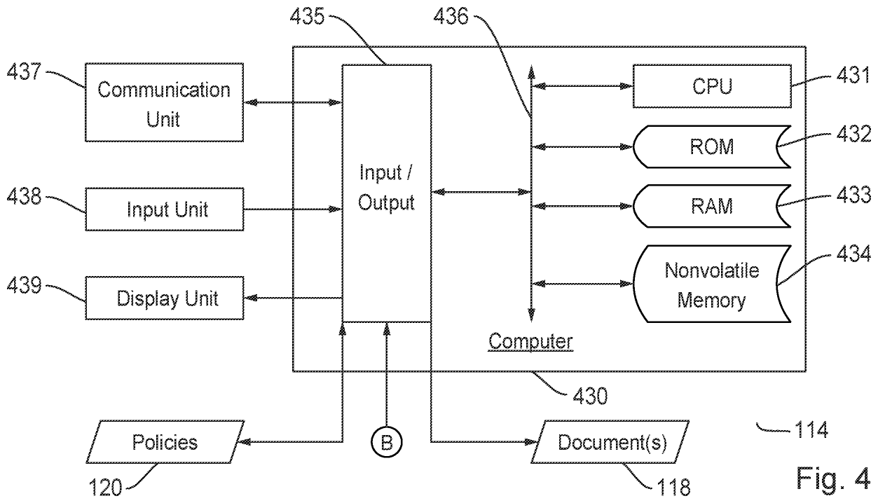

FIG. 4 depicts document management server 114 for managing categorized documents 118 within document management system 100 according to the disclosed embodiments. Document management server 114 may be configured using a computer 430. Computer 430 includes a central processing unit (CPU) 431, which is an example of a processor that executes a process of document management server 114 according to the disclosed embodiments, a read-only memory (ROM) 432 that stores instructions and software that configures computer 430 to function as document management server 114, a random access memory (RAM) 433 used as a temporary network area of CPU 431, a nonvolatile memory 434, and an input/output interface (I/O) 435. CPU 431, ROM 432, RAM 433, nonvolatile memory 434, and I/O 435 are connected to each other via bus 436. Nonvolatile memory 434 may be a storage device that retains stored information even in a case where the power supplied to the nonvolatile memory is cut off.

Document management server 114 also may include communication unit 437, an input unit 438, and display unit 439 that are connected to I/O 435. These features may be configured outside of computer 430 but still part of the server. Communication unit 437 is connected to lines within document management system 102, includes those to processing unit 112 and project management tool 116. Communication unit 437 also may be connected to user devices 104, 106, and 108. Communication unit 437 may implement a communication protocol for performing data communications with user devices 104, 106, and 108.

Input unit 438 is a device that receives an instruction from one of the user devices or other components within document management system 100. It notifies CPU 431 of the instruction. The instruction may be a signal or data from a user device requesting access to documents 118 stored at document management server 114. Display unit 439 may visually display information processed by CPU 431. Display unit 439 may be a liquid crystal display, an organic electro-luminescence (EL) display, and the like.

Documents 118 are stored at document management server 114. They may be stored according to their categories. Computer 430 may access documents 118 when requested. User devices 104, 106, and 108 may access documents 118 on document management server 114 to retrieve discussions and noted categorized therein. For example, members of the various project teams may wish to review the saved documents from meetings on meeting platform 102. Access, however, may be limited by policies 120. Policies 120 may be one or more policy that governs how documents 118 are accessed, and who has access to which documents.

For example, policies 120 may be defined by an administrator within document management system 100. Upon receiving a request or access by a user, document management system 100 or document management server 114 finds the categories and documents that can be accessed by the user according to policies 120. Document management system 100 then may display the categories and documents available to the user.

Examples of policies 120 include a policy that specifies each member can access categories under his/her name. Another policy may specify that each member can access categories in his/her group, such as a project group or working group. A group also may refer to an organization. Another policy may specify that each member can access categories of the project that the member is involved. Another policy may specify that each member can access the documents which have his/her name mentioned. Other policies also may be implemented.

Thus, document management server 114 may receive, store, and manage access to documents 118. Document management system 100 may implement additional document management servers as needed. Further, these servers may be dedicated to specific categories within the document library. A control management server then may be used to route access requests to the proper document management server within document management system 100.

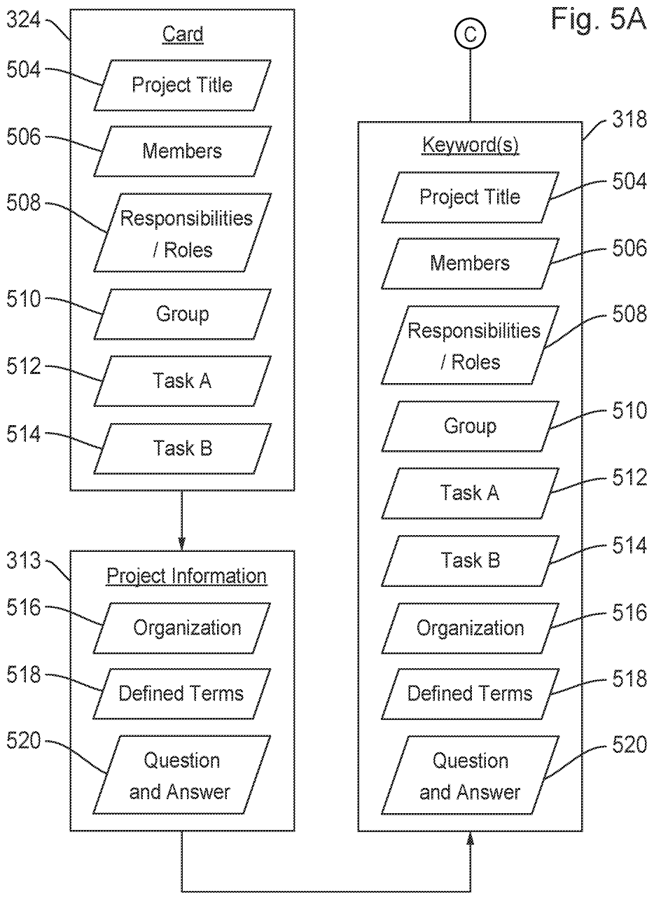

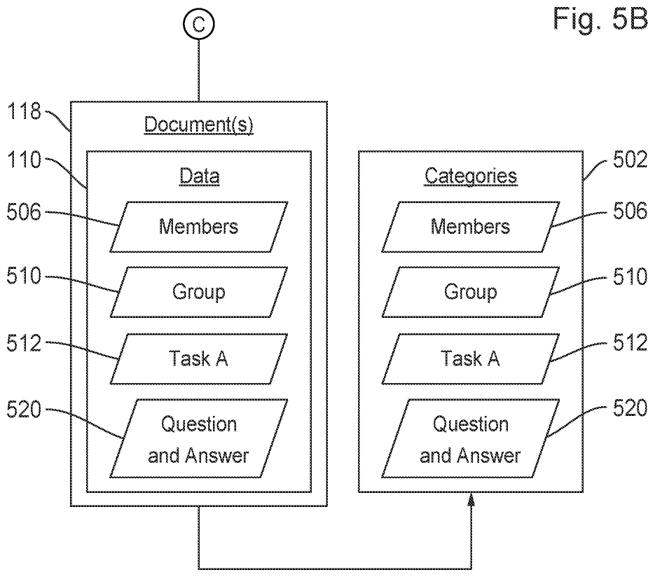

FIGS. 5A and 5B depict a flow diagram of a document 118 being categorized according to keywords 318 according to the disclosed embodiments. FIGS. 5A and 5B illustrate the embodiments disclosed by FIGS. 1-4 in greater detail. As shown, card 324 and project information 313 are used to generate keywords 318, which are used to categorize document 118 into one or more categories 502. FIGS. 5A and 5B show an example of this process.

Card 324 may be provided by or related to project management tool 116, shown in FIG. 1. Project management tool 116 may be a task management system to keep track of projects and tasks within an organization or implemented over a network. As projects are developed, members and tasks are assigned to a group working on the project. Project management tool 116 tracks the tasks and provides a resource to store data related to the project. Example of a project management tool may be product management software or an issue tracking product.

In defining and tracking projects, cards 324 are electronic documents that may be generated to help in the tracking of tasks and providing information about the project or group. Card 324 may refer to a feature or function in the project that members need to address or work on. Card 324 makes it easy to keep track of the details and the progress of the development of each individual feature or function. For example, card 324 may include information provided that pertains to the details and progress.

Information provided on card 324 may include project title 504, members on the project or associated with the card 506, responsibilities/roles within the project 508, an applicable group or group name 510, and task A 512 and task B 514 to be executed to develop the feature or function of the card. These items may be identified as keywords within card 324. Document management system 100 may track these items in categories for generated documents 118. Card 324 also includes other information that is not particularly germane to finish the project. This information is not used as keywords.

Card 324 may be merged into projection information 313, or treated separately. Project information 313 includes potential keywords defined within document management system 100. For example, such potential keywords may relate to organization 516. A keyword for organization 516 may include department names, or organization terms not related to a specific project. Other potential keywords may be defined terms 518, such as software development or other categories of interest to the organization but not captured in a card. The disclosed embodiments allow document management system 100 to define these terms to set up categories. Potential keywords also include question and answer 520, which is disclosed in greater detail below.

From project information 313 and card 324, keywords 318 are determined within processing engine 112. As disclosed above, these terms may be determined by looking at various fields within card 324 or data received with project information 313. In this instance, keywords 318 include the terms identified above. Thus, keywords 318 include organization 516, group 510, members 506, project title 504, responsibilities/roles 508, tasks 512 and 514, defined terms 518, and question and answer 520.

Processing engine 112 then uses keywords 318 to identify terms within textual data 110 of document 118 obtained from meeting platform 102. Document 118 is generated using data 110 and is embedded within the document. For example, document 118 may include terms related to group 510, task 512, members 506, and question and answer 520. Document 118, therefore, may include discussion naming the group and members associated with the meeting. It also includes discussion about a task assigned to the group and members. During the meeting, questions and answers were provided.

The question and answer category may be shown below. Processing engine 112 may search for those occasions where a question is asked and answered in the meeting discussion and notes. Such information may be of particular interest as it identifies something that was deemed important enough to ask about. Further, the answers may provide specific information of interest in the document as opposed to discussions or notes that do not explicitly mention the information.

For example, data 110 of document 118 may include text having the following:

Q: What are the main features of KCPS 1.2?

A1: [Jin] We need to implement user pin code authentication, new contract report, FAX to storage.

A2: [Martin] We also need to support new cloud storage accounts like SharePoint, OneDrive Business.

The disclosed embodiments identify this text for a category for question and answer 520. Users may see, or search, the list of questions and their answers from documents analyzed within document management system 100.

As shown in FIGS. 5A and 5B, at least one keyword is found within document 118. Thus, document 118 will be categorized by processing engine 112 into categories related to the identified keywords. Thus, document management server 114 may store document 118 of FIGS. 5A and 5B in four categories available on document management system 100. It may be stored in the category of categories 502 for the term defined by group 510 found on card 324. It also will be stored in the category for the members named on card 324. Further, it also will be placed under the category associated with task 512. Document 118 also will be stored under the question and answer category.

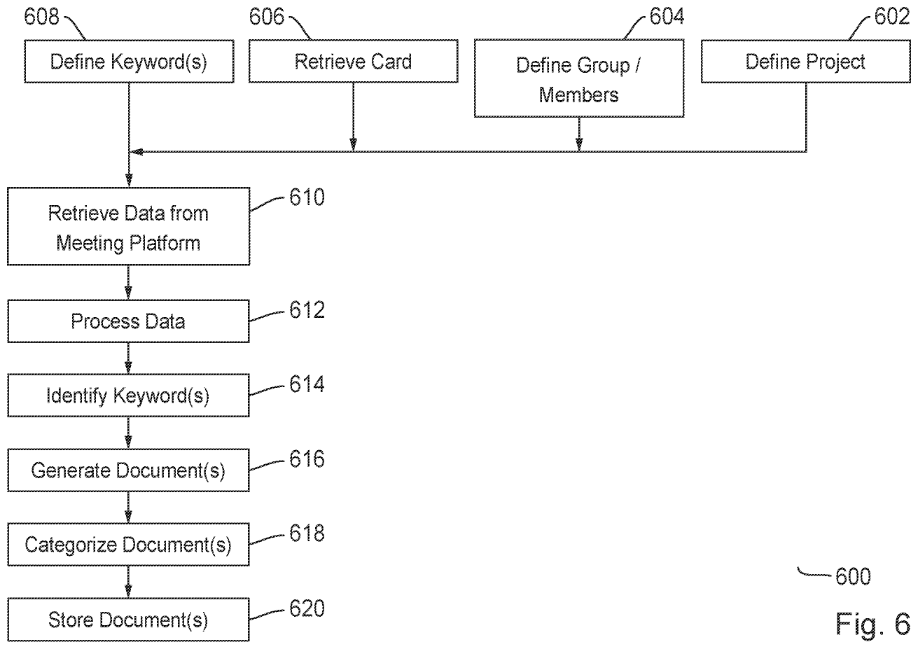

FIG. 6 depicts a flowchart 600 for categorizing a document 118 related to notes and discussions of a meeting according to the disclosed embodiments. Flowchart 600 may refer back to FIGS. 1-5B for illustrative purposes. Flowchart 600, however, is not limited by the features of FIGS. 1-5B.

Steps 602 and 608 may related to those actions taken before data 110 is received by processing engine 112 to generate and categorized it into a document. Step 602 executes by defining a project within document management system 100. The project may include groups, members, tasks, and other items that need to be accomplished. These terms may become the basis for keywords 318. Step 604 executes by defining any groups along with members that are application to the project. Alternatively, the groups and members may be standing ones within an organization, such as the hardware group that is involved in several projects.

Step 606 executes by retrieving one or more cards 324 from project management tool 116. This feature may be performed daily to obtain cards newly generated using project management tool 116. Alternatively, cards 324 may be submitted to document management system 100 when they are generated, though this may not be recommended due to typing up resources. Step 608 executes by defining one or more keywords for use within document management system 100. An example may be a term related to something not specifically defined in a project, group, or card. This feature allows administrators to set up categories for classifying documents that does not fit within other defined parameters.

Step 610 executes by retrieving data 110 from meeting platform 102. Preferably, data 110 is textual data in the form of texts or ASCII codes. As disclosed above, document management server 114 may instruct processing engine 112 to retrieve meeting data from meeting platform 102 at specified times during the day. Step 612 executes by processing data 110 to identify at least one keyword 318 within the data. The keywords determined from the information provided within document management system 100 are compared to the text in data 110.

Step 614 executes by identifying one or more keywords 318 within data 110. Step 616 executes by generating document 118 by processing engine 112, including data 110. Step 618 executes by categorizing document 118 according to the identified keywords within the document into a category within document management system 100. As disclosed above, the category may be based on or match the keyword. In some embodiments, the keywords may be related to categories though not necessarily the category name. These relationships may be defined within document management system 100. Step 620 executes by storing document 118 into one or more categories 502 on document management server 114.

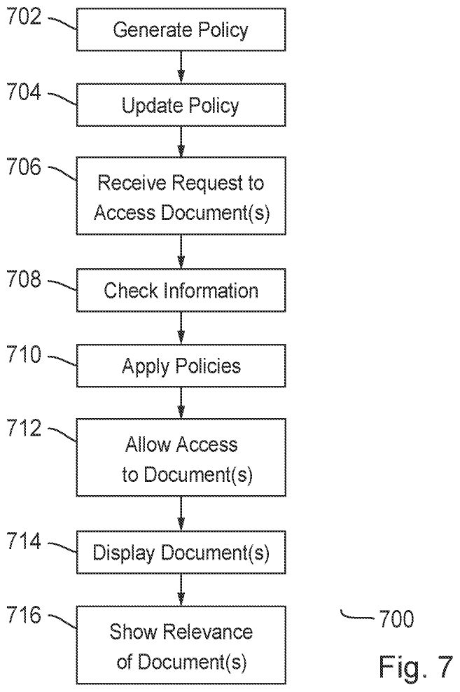

FIG. 7 illustrates a flowchart for accessing categorized documents within the document management system according to the disclosed embodiments. Flowchart 700 may refer back to FIGS. 1-6 for illustrative purposes. Flowchart 700, however, is not limited by the features of FIGS. 1-6.

Step 702 executes by generating one or more policies regarding access to documents 118 stored on document management server 114. As disclosed above, a policy controls access to the documents based on criteria, such as parameters associated with a user trying to obtain access. The policy may allow access based on member name, groups, projects, or account name Step 704 executes by updating one or more policies with a member name or member account. In other words, a new employee may join a group that has access to documents 118. The member name or other information is added to the applicable policy to allow the access.

Step 706 executes by receiving a request from a user to access documents 118 stored and categorized on document management server 114. The user may log onto document management system 100 using user device 104. Step 708 executes by checking information pertaining to the user, such as member name, member account, employee number, groups, projects, and the like. These items may not necessarily be related to keywords 318 used to categorize documents 118.

Step 710 executes by applying policies 120 to the information provided for the user to determine what categories 502 that the user can access on document management server 114. As noted above, a policy may indicate that the user belongs to three groups and works on two projects. Further, the user may be a manager and has access to the question and answer category documents. Thus, the policy allows the user to access those categories related to the member name, three groups, two projects, a role as a manager, and the question and answer documents. Step 712 executes by allowing access to at least one document 118 based on the policy at document management server 114.

Step 714 executes by displaying one or more documents 118 at user device 104. The displayed documents are the ones allowed by policies 120. The user may select a document to review and the data obtained for viewing from document management server 114. Step 716 executes by showing relevance of the selected document to other categories. When documents are listed under one category, the disclosed embodiments may show the relevance to other categories. For example, under the “LiteDMS” category for a project, a document is relevant to another category “Jin Liang,” which is a member name Thus, one can see the relevance that a document might have within document management system 100. A document for an important meeting discussion and notes may pertain to many categories.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for automatically processing data for meetings and discussions in a document management system, the method comprising:
retrieving textual data from a third-party meeting platform;
processing the textual data to identify at least one keyword using a processing engine;
generating at least one document from the textual data;
categorizing the at least one document according to the at least one keyword into a category within the document management system;
storing the at least one document at a document management server under the category;
receiving a request to access the at least one document from the category within the document management system; and
allowing access to the at least one document based on a policy at the document management server.

2. The method of claim 1, further comprising defining the at least one keyword prior to retrieving the textual data.

3. The method of claim 1, wherein the at least one keyword is related to a project for a meeting on the third-party meeting application that generates the textual data.

4. The method of claim 1, wherein categorizing the at least one document includes categorizing according to a project for a meeting on the third-party meeting application.

5. The method of claim 1, wherein categorizing the at least one document includes categorizing according to a member name or member user account related to a meeting on the third-party meeting application.

6. The method of claim 5, further comprising updating the policy with the member name or member user account.

7. The method of claim 1, further comprising showing a relevance of the at least one document between the category and another category within the document management system.

8. The method of claim 1, further comprising determining a user can access the category and the at least one document based on the policy.

9. A method for automatically processing data for meetings and discussions in a document management system, the method comprising:
defining a project within the document management system;
using a processing engine, calling an application programming interface to retrieve a card from a task management system related to the project;
retrieving textual data from a third-party meeting platform related to the project or the card;
processing the textual data to identify at least one keyword associated with the project using the processing engine;
generating a document from the textual data;
categorizing the document according to the at least one keyword into a category under the project within the document management system;
storing the document at a document management server under the category for the project;
receiving a request to access the document from the category within the document management system; and
allowing access to the document based on a policy related to the project at the document management server.

10. The method of claim 9, wherein the card retrieved from the task management system is an electronic document.

11. The method of claim 9, wherein categorizing the document includes categorizing according to a member name or member user account related to the project.

12. The method of claim 11, further comprising updating the policy with the member name or member user account.

13. The method of claim 9, further comprising determining a user can access the category and the document based on the policy.

14. The method of claim 9, further comprising creating the project within the document management system.

15. A method for automatically processing data for meetings and discussions in a document management system, the method comprising:
defining a group within the document management system, wherein the group includes at least one member account;
retrieving textual data from a third-party meeting platform related to the group;
processing the textual data to identify the at least one member account associated with the group using a processing engine;
generating a document from the textual data;
categorizing the document according to the at least one member account into a category for the group within the document management system;
storing the one document at a document management server under the group;
receiving a request to access the document from the category within the document management system; and
allowing access to the document based on a policy related to the project at the document management server.

16. The method of claim 15, further comprising defining a project within the document management system.

17. The method of claim 16, further comprising defining at least one keyword related to the project.

18. The method of claim 17, further comprising categorizing the document within the group according to the at least one keyword.

19. The method of claim 18, further comprising storing the document under the project within the document management system.

20. The method of claim 19, further comprising indicating that the document belongs to the group and the project within the document management system.
